(19) United States
(12) Patent Application Publication
(10) Pub. No.: US 2009/0310982 A1
(43) Pub. Date: Dec. 17, 2009

(54) IMAGE FORMING APPARATUS AND CONTROL METHOD FOR IMAGE FORMING APPARATUS

(75) Inventors: Shinichiro MANO, Hadano-shi (JP); Katsuya SASAHARA, Izu-shi (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/483,138

(22) Filed: Jun. 11, 2009

Related U.S. Application Data
(60) Provisional application No. 61/061,985, filed on Jun. 16, 2008.

(51) Int. Cl. G03G 15/00

(52) U.S. Cl. 399/18

(57) ABSTRACT

An image forming apparatus includes a first conveying unit that conveys a sheet, an image forming unit that forms an image on the sheet, a switch that switches a discharge destination for the sheet having the image formed thereon to a first direction and to a second direction, a stacking tray on which the sheet conveyed in the first direction is stacked, and a second conveying unit that conveys the sheet conveyed in the second direction. When occurrence of a jam is detected in the second conveying unit, the image forming apparatus controls the switch to switch the discharge destination of the sheet to the first direction.

### CROSS REFERENCE TO RELATED APPLICATION

This application is based upon and claims the benefit of priority from: U.S. provisional application 61/061,985, filed on Jun. 16, 2008, the entire contents of each of which are incorporated herein by reference.

### TECHNICAL FIELD

Described herein relates to an image forming apparatus for obtaining a copy image or a printout of an object and a control method for the image forming apparatus.

### BACKGROUND

As a function connected to an image forming apparatus, for example, there is a post-processing apparatus (a finisher). The finisher includes a stapler that performs processing for storing printed-out plural sheets in a stacked state and stapling the sheets. The finisher staples a predetermined number of printed-out sheets as one set and stores a large number of sets.

The image forming apparatus conveys, in the apparatus, sheets used for printing, performs printing, and discharges the sheets from a discharge port. The finisher receives the sheets discharged from the image forming apparatus and conveys the sheets to the stapler. The finisher discharges the sheets stapled by the stapler.

When a sheet jam occurs in the finisher, it is necessary to stop the processing by the image forming apparatus and the finisher. An image forming system disclosed in JP-A-2008-65178 sets, when abnormality requiring stop of conveyance of sheets occurs in a finisher, a state of the finisher in a paper jam state and stops processing in an image forming apparatus.

The image forming system stops the processing by the image forming apparatus and the finisher when a jam occurs in the finisher connected to the image forming apparatus. This takes time and labor because it is necessary to remove sheets even from an image forming apparatus in which a jam does not occur.

### SUMMARY

Described herein relates to an image forming apparatus including: a first conveying unit that conveys a sheet; an image forming unit that applies image forming processing to the sheet conveyed by the first conveying unit; a first discharge port for leading the sheet subjected to the image forming processing by the image forming unit into an external apparatus; a second discharge port for discharging the sheet in a state in which the sheet can be taken out from the outside; a switch that switches a discharge destination for the sheet to the first discharge port and to the second discharge port; a second conveying unit that conveys the sheet discharged from the first discharge port; a post-processing unit that applies post processing to the sheet conveyed by the second conveying unit; a first jam detecting unit that detects occurrence of a jam in the first conveying unit; a second jam detecting unit that detects occurrence of a jam in the second conveying unit; and a control unit that controls, when occurrence of a jam is detected by the second jam detecting unit, the switch to switch the discharge destination for the sheet to the second discharge port.

Described herein relates to a method for controlling an image forming apparatus, including: conveying a sheet through a first conveying unit; forming an image on the sheet conveyed from the first conveying unit; switching a switch to convey the sheet having the image formed thereon in a second direction; conveying, through a second conveying unit, the sheet conveyed in the second direction; subjecting the sheet conveyed through the second conveying unit to post processing; detecting that a jam does not occur in the first conveying unit and a jam occurs in the second conveying unit; switching the switch to convey the sheet having the image formed thereon in a first direction; and stacking the sheet conveyed in the first direction.

Additional objects and advantages of the embodiments will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

FIG. 1 is a diagram for schematically explaining a configuration of an image forming apparatus;

FIG. 2 is a block diagram of a control system for a main body of the image forming apparatus;

FIG. 3 is a block diagram of a control system for a finisher of the image forming apparatus; and

FIG. 4 is a flowchart for explaining the operation of the main body of the image forming apparatus.

### DETAILED DESCRIPTION

An embodiment of the present invention is explained below with reference to the accompanying drawings.

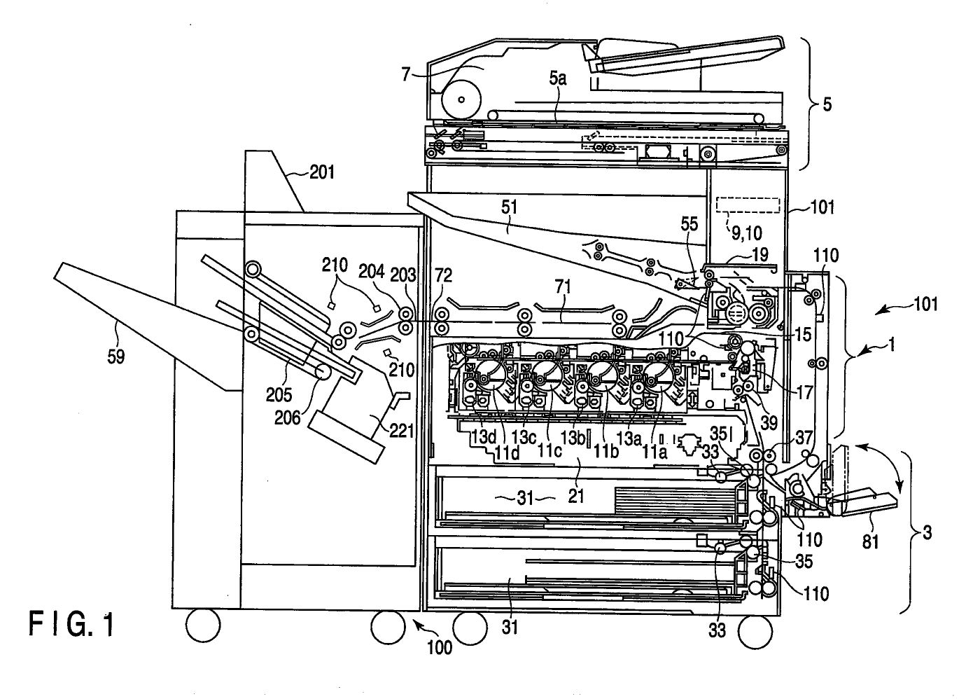

FIG. 1 is a schematic diagram of an image forming apparatus 100.

The image forming apparatus 100 includes a main body 101 and a finisher 201.

The main body 101 includes an image forming unit 1, a sheet feeding unit 3, and an image scanning unit 5. The image forming unit 1 prints out an image. The sheet feeding unit 3 feeds a sheet for the print-out to the image forming unit 1.

The image scanning unit 5 captures image information from an original document as image data. The image forming unit 1 outputs the image data, which is supplied from the image scanning unit 5, to the sheet fed from the sheet feeding unit 3.

The image scanning unit 5 includes a CCD sensor. The CCD sensor acquires the image data from the original document placed on a document table 5a. The image scanning unit 5 includes an automatic document feeder (ADF) 7.

The ADF 7 takes in sheet-like original documents one by one, conveys the original document through a conveying path in the ADF 7, and discharges the original document from a discharge position. The ADF 7 includes the CCD sensor near the conveying path in the ADF 7. The ADF 7 takes in the original documents one by one and acquires image data from the original document being conveyed.

The main body 101 includes an operation unit 9 and a display unit 10 on an apparatus surface. The operation unit 9 includes, for example, a control panel. The display unit 10 includes a display device such as a liquid crystal panel. The display unit 10 functions as a notifying unit. The operation unit 9 and the display unit 10 may be integrated as a touch panel or the like.

The image forming unit 1 starts image forming processing when the image formation is instructed through the operation unit 9. The image scanning unit 5 starts scanning of an original document when the scanning of the original document is instructed through the operation unit 9.

The image forming unit 1 includes photoconductive drums 11a to 11d, developing devices 13a to 13d, a transfer belt 15, a transfer device 17, a fixing device 19, and an exposing device 21.

The photoconductive drums 11a to 11d carry latent images. The developing devices 13a to 13d develop the latent images formed on the photoconductive drums 11a to 11d. The transfer belt 15 carries, in a layered state, images of developers developed by the developing devices 13a to 13d on the photoconductive drums 11a to 11d.

The transfer device 17 transfers the images of the developers layered on the transfer belt 15 onto a sheet-like transfer medium (hereinafter referred to as sheet) such as general plain paper not specially processed or an OHP sheet, which is a transparent resin sheet. The fixing device 19 fixes the images of the developers, which are transferred onto the sheet, on the sheet. The exposing device 21 forms latent images on the photoconductive drums 11a to 11d.

The image forming unit 1 includes the photoconductive drums 11a to 11d to correspond to colors Y (yellow), M (magenta), C (cyan), and Bk (black), respectively. The developing devices 13a to 13d store developers corresponding to the colors, respectively.

The photoconductive drums 11a to 11d carry latent images developed by the developing devices 13a to 13d corresponding to the photoconductive drums 11a to 11d, respectively. The order of arrangement of the photoconductive drums 11a to 11d and the developing devices 13a to 13d is specified as order corresponding to an image forming process and characteristics of the developers.

The transfer belt 15 carries, in order of formation, developer images of the colors formed on the photoconductive drums 11a to 11d by the developers of the developing devices 13a to 13d, respectively.

As explained above, the sheet feeding unit 3 feeds a sheet used for transfer processing to the transfer device 17 at predetermined timing. The transfer device 17 transfers, using the transfer belt 15, the developer images onto the sheet fed by the sheet feeding unit 3.

The sheet feeding unit 3 includes a cassette slot 31. The cassette slot 31 includes a structure in which a cassette is set. The cassette stores sheets of an arbitrary size.

The sheet feeding unit 3 takes out sheets from the cassette slot 31 with a pickup roller 33 on the basis of the control by a control system explained later. The sheet feeding unit 3 includes a separating mechanism 35 at a post stage of the pickup roller 33. The separating mechanism 35 prevents two sheets from being taken out at a time by the pickup roller 33.

Plural conveying rollers 37 convey the sheet that passes through the separating mechanism 35 to an aligning roller 39. The aligning roller 39 conveys, at timing when the transfer is performed in the transfer device 17, the sheet to a transfer position where the transfer device 17 and the transfer belt 15 are set in contact with each other. The pickup roller 33, the conveying roller 37, the aligning roller 39, and the like function as a conveying unit.

The sheet feeding unit 3 includes a manual feed tray 81. The sheet feeding unit 3 picks up a sheet placed on the manual feed tray 81 and conveys the sheet to the conveying roller 37.

The sheet feeding unit 3 includes a plurality of the cassette slots 31, the pickup rollers 33, and the separating mechanisms 35 when necessary.

The fixing device 19 fixes image information transferred onto the sheet by the transfer belt 15. The sheet having the image information fixed thereon is conveyed to a paper discharge tray 51 or a relay conveying path 71.

The main body 101 includes a switch 55. The switch 55 switches a conveying destination of the sheet that passes through the fixing device 19 to a first direction and to a second direction. For this purpose, the switch 55 includes a switching structure employing various well-known methods such as an electromagnet.

The main body 101 includes the paper discharge tray 51 on which the sheet conveyed in the first direction is stacked. The paper discharge tray 51 is a discharge port for the sheet provided below the image scanning unit 5 and above the image forming unit 1.

The main body 101 includes a discharge port 72 for discharging the sheet. The relay conveying path 71 conveys the sheet conveyed in the second direction to the discharge port 72 provided on a side of the main body 101. When the finisher 201 is connected to the main body 101, a sheet feeding unit 203 of the finisher 201 is connected to the discharge port 72. In this case, the sheet conveyed through the relay conveying path 71 is led into the sheet feeding unit 203 of the finisher 201.

The finisher 201 includes the sheet feeding unit 203, a stapler 221, and a paper discharge tray 59.

The sheet feeding unit 203 receives the sheet discharged from the discharge port 72. For this purpose, the sheet feeding unit 203 includes rollers 204 and the like. The sheet feeding unit 203 conveys the sheet received by the rollers into the finisher 201.

The sheet conveyed into the finisher 201 is stacked on a stacker 205 in the finisher 201. The finisher 201 includes the stacker 205 to be adjacent to the stapler 221. The stapler 221 is a post-processing unit and applies stapling to plural sheets. When the finisher 201 determines that the number of sheets stacked on the stacker 205 reaches a predetermined number, the finisher 201 staples plural sheets stacked on the stacker 205 with the stapler 221. The finisher 201 discharges the stapled sheets from the paper discharge tray 59 with a conveying roller 206. The rollers 204 and the conveying roller 206 function as a conveying unit.

The main body 101 and the finisher 201 of the image forming apparatus 100 include plural sensors 110 and 210.

The sensors 110 are provided in units in the main body 101 of the image forming apparatus 100. The sensors 110 detect a sheet passing state in the main body 101. For this purpose, the main body 101 includes the sensors 110 near conveying rollers and a conveyor belt in the main body 101.

The sensors 110 monitor predetermined positions on a conveying path in the main body 101 and transmit detection signals to a CPU of the main body 101 explained later. For example, when a sheet passes on the conveying path, a level of the detection signals changes. The CPU of the main body 101 detects a jam in the main body 101 on the basis of the level of the detection signals received from the sensors 110.

The sensors 210 are provided in units in the finisher 201 of the image forming apparatus 100. The sensors 210 detect a sheet passing state in the finisher 201. For this purpose, the finisher 201 includes the sensors 210 near conveying rollers and a conveyor belt in the finisher 201.

The sensors 210 monitor predetermined positions on a conveying path in the finisher 201 and transmit detection signals to a CPU of the finisher 201 explained later. For example, when a sheet passes on the conveying path, a level of the detection signals changes. The CPU of the finisher 201 detects a jam in the finisher 201 on the basis of the level of the detection signals received from the sensor 210.

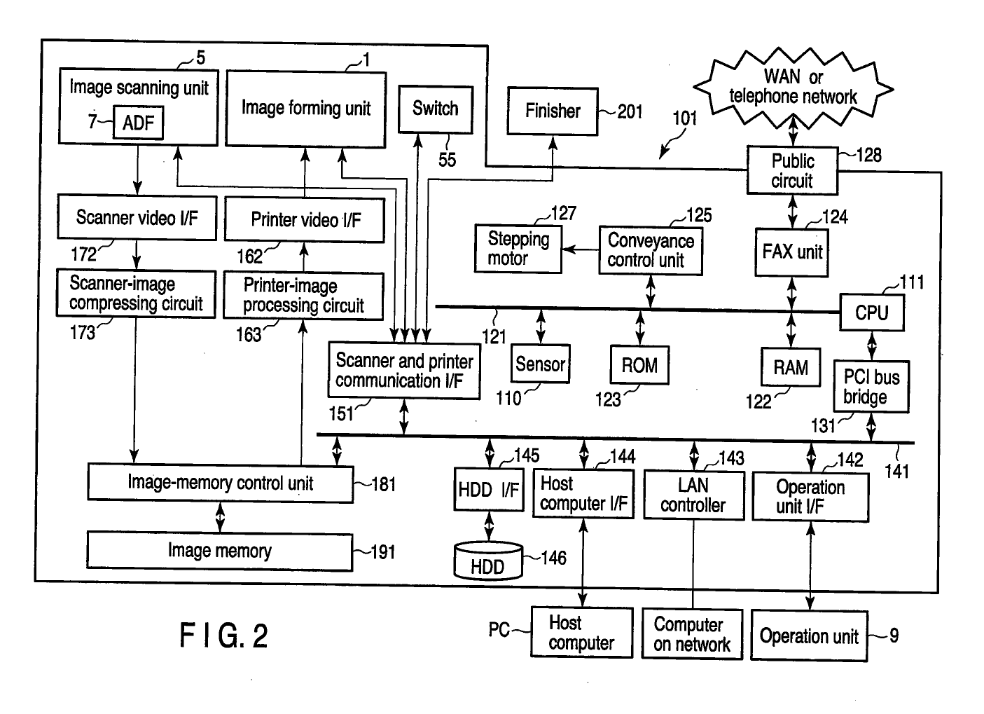

FIG. 2 is a block diagram for explaining a control system for the main body 101 of the image forming apparatus 100 shown in FIG. 1.

The main body 101 of the image forming apparatus 100 includes a main control block (CPU) 111, a CPU local bus 121, a peripheral component interconnect (PCI) bus bridge 131, and a PCI bus 141. The CPU local bus 121 is connected to the CPU 111. The PCI bus 141 is connected to the CPU 111 via the PCI bus bridge 131.

The CPU 111 functions as a control unit that manages the control of the entire main body 101 of the image forming apparatus 100. The CPU 111 performs various kinds of processing on the basis of a control program and control data stored in a ROM or a nonvolatile memory.

A RAM 122, a ROM 123, and the like are connected to the CPU local bus 121. The RAM 122 is a volatile memory that functions as a working memory. The RAM 122 temporarily stores data and the like being processed by the CPU 111. Further, the RAM 122 temporarily stores a program executed by the CPU 111.

The ROM 123 functions as a storage area for stationary data such as a boot program necessary for system startup and a program for the CPU 111 to realize various functions. The ROM 123 stores a control program, control data, and the like at a manufacturing stage. In other words, the ROM 123 stores the control program and the control data according to specifications of the image forming apparatus 100 in advance.

For example, a facsimile unit 124 is connected to the CPU local bus 121.

The facsimile unit 124 is an interface for connecting the main body 101 to a public line 128. The main body 101 is connected to a wide area network (WAN), a telephone network, or the like via the facsimile unit 124. The main body 101 receives image data for image output from the WAN, the telephone network, or the like and prints out the image data.

An operation unit I/F 142, a LAN controller 143, a host computer I/F 144, a HDD I/F 145, a scanner and printer communication I/F 151, and the like are connected to the PCI bus 141.

The operation unit I/F 142 is connected to the operation unit 9. The operation unit I/F 142 receives an operation signal transmitted from the operation unit 9. The operation unit I/F 142 transmits the received operation signal to the CPU 111.

The LAN controller 143 communicates with a computer present on a network formed by a LAN. The main body 101 transmits and receives data to and from the computer present on the network via the LAN controller 143.

The host computer I/F 144 is connected to an external apparatus, for example, a host computer PC. The main body 101 transmits and receives data to and from the host computer PC via the host computer I/F 144. The host computer I/F 144 is an interface that performs communication according to a system specified by Ethernet (registered trademark), universal serial bus (USB), IEEE1284, IEEE1394, or the like.

The HDD I/F 145 is connected to a HDD (hard disk drive) 146. The HDD 146 is a storage device that stores a large volume of data. The CPU 111 reads out data from and writes data in the HDD 146 via the HDD I/F 145.

The scanner and printer communication I/F 151 is an interface to which the image forming unit 1, the image scanning unit 5, the switch 55, the finisher 201, and the like are connected. The CPU 111 transmits and receives data to and from and exchanges control signals with the image forming unit 1, the image scanning unit 5, the switch 55, and the finisher 201 via the scanner and printer communication I/F 151.

The CPU 111 exchanges the control signals to thereby perform scanning of color or monochrome image information by the image scanning unit 5 and output of image information by the image forming unit 1.

The CPU 111 controls the switch 55 to thereby switch whether a sheet is discharged from the discharge port 72 or discharged to the paper discharge tray 51. When the finisher 201 is connected to the main body 101, the CPU 111 controls the switch 55 to discharge the sheet from the discharge port 72 during normal time.

The CPU 111 performs various kinds of processing on the basis of various codes transmitted from the CPU of the finisher 201.

An image-memory control unit 181 is connected to the PCI bus 141. The image-memory control unit 181 controls an image memory 191. The image-memory control unit 181 is connected to the image scanning unit 5 via a scanner video I/F 172 and a scanner-image compressing circuit 173. The image-memory control unit 181 is connected to the image forming unit 1 via a printer video I/F 162 and a printer-image processing circuit 163.

When the image scanning unit 5 scans an image, the scanner-image compressing circuit 173 applies compression processing to scanned image data. The image-memory control unit 181 stores the compressed image data subjected to the compression processing in the image memory 191.

When the image forming unit 1 forms an image, the image-memory control unit 181 reads out, from the image memory 191, data to be output and outputs the data to the printer-image processing circuit 163. The printer-image processing circuit 163 applies decoding processing to the received data, converts an image format according to specifications of the image forming unit 1, and outputs the data to the image forming unit 1. As explained above, the image forming unit 1 controls the photoconductive drums 11a to 11d, the developing devices 13a to 13d, the transfer belt 15, the transfer device 17, the fixing device 19, and the exposing device 21 on the basis of the received data and performs image formation.

As explained above, for example, the image-memory control unit 181 stores read image data in the image memory 191 and reads out, from the image memory 191, image data to be output. The image-memory control unit 181 copes with handling of image data of various formats.

For example, when a user requests the image forming apparatus 100 to perform print-out with the host computer PC, a control signal is input to the CPU 111 via the host computer I/F 144 and the PCI bus 141.

When image data that should be printed out is received via the host computer I/F 144 and the PCI bus 141, the image-memory control unit 181 stores the image data in the image memory 191.

The CPU 111 determines, on the basis of the received control signal, processing to be executed and transmits control signals to the respective units of the main body 101. The CPU 111 instructs the image-memory control unit 181 to read out the received image data. The image-memory control unit 181 reads out the image data from the image memory 191 and outputs the image data to the printer-image processing circuit 163. The CPU 111 instructs the image forming unit 1 to perform image forming processing. The image forming unit 1 performs the image forming processing on the basis of the image data received via the printer video I/F 162.

The sensors 110 and a conveyance control unit 125 are connected to the CPU local bus 121. The conveyance control unit 125 drives a stepping motor 127 on the basis of the control by the CPU 111. The stepping motor 127 transmits power to the conveying rollers of the units shown in FIG. 1. Consequently, the conveyance control unit 125 collectively controls the conveyance of a sheet in the main body 101.

As explained above, the sensors 110 monitor the predetermined positions on the conveying path in the main body 101 and transmit detection signals to the CPU 111. For example, when a sheet passes on the conveying path, a level of the detection signals changes. The CPU 111 detects a jam in the main body 101 on the basis of the level of the detection signals received from the sensors 110.

When the sheet passes the monitoring positions of the sensor 110, the detection signals change from a Low level to a High level. When High level signals are continuously received, the CPU 111 counts time. When the CPU 111 determines that a size of the sheet being conveyed and the counted time are unbalanced, the CPU 111 detects that a jam occurs. The CPU 111 and the sensors 110 function as a jam detecting unit.

When Low level signals are continuously received, the CPU 111 counts time. The CPU 111 transmits control signals to the units to convey the sheet, counts time during which the Low level signals are continuously received, and detects, when the counted time exceeds the predetermined time, that a jam occurs. The predetermined time used for this determination is stored in the ROM 123 or the like in advance.

For this purpose, the CPU 111 stores values of the High level and the Low level in the ROM 123 or the like in advance. The CPU 111 compares the values stored in the ROM 123 or the like and values of detection signals and determines whether a level of signals received from the sensors 110 is the High level or the Low level.

When the CPU 111 detects that a jam occurs on the basis of the detection signals received from the sensors 110, the CPU 111 transmits an error code to the CPU 211 of the finisher 201. The detection of a jam by the CPU 111 explained above is only an example. Other methods may be used for the detection of a jam.

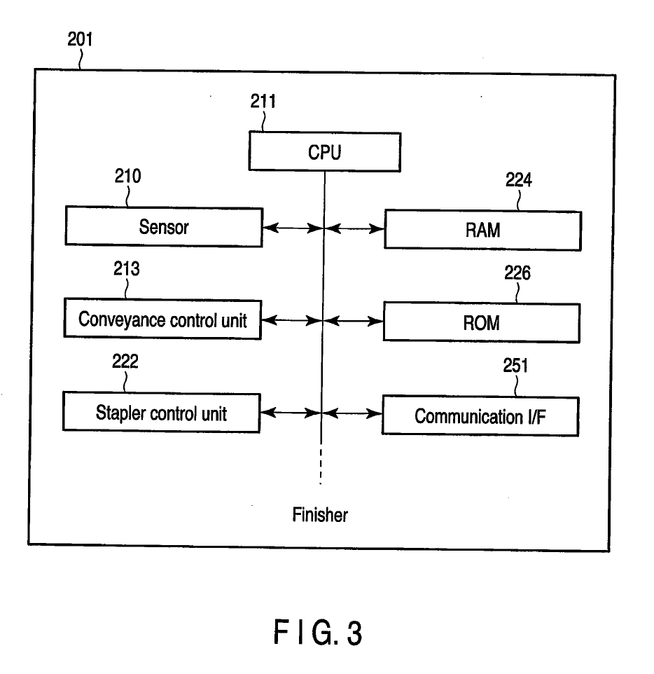

FIG. 3 is a block diagram for explaining a control system for the finisher 201 of the image forming apparatus 100 shown in FIG. 1.

The finisher 201 of the image forming apparatus 100 includes the CPU 211, the sensors 210, a conveyance control unit 213, a stapler control unit 222, a RAM 224, and a ROM 226.

The CPU 211 functions as a control unit that manages the control of the entire finisher 201 of the image forming apparatus 100. The CPU 211 performs various kinds of processing on the basis of a control program and control data stored in a ROM or a nonvolatile memory.

The RAM 224 is a volatile memory that functions as a working memory. The RAM 224 temporarily stores data and the like being processed by the CPU 211. Further, the RAM 224 temporarily stores a program executed by the CPU 211.

The ROM 226 functions as a storage area for stationary data such as a boot program necessary for system startup and a program for the CPU 211 to realize various functions. The ROM 226 stores a control program, control data, and the like at a manufacturing stage. In other words, the ROM 226 stores the control program and the control data according to specifications of the finisher 201 in advance.

As explained above, the sensors 210 monitor the predetermined positions on the conveying path in the finisher 201 and transmit detection signals to the CPU 211. For example, when a sheet passes on the conveying path, a level of the detection signals changes. The CPU 211 detects a jam in the finisher 201 on the basis of the level of the detection signals transmitted from the sensors 210.

When the sheet passes the monitoring positions of the sensor 210, the detection signals change from a Low level to a High level. When High level signals are continuously received, the CPU 211 counts time. When the CPU 211 determines that a size of the sheet being conveyed and the counted time are unbalanced, the CPU 211 detects that a jam occurs. The CPU 211 and the sensors 210 function as a jam detecting unit.

When Low level signals are continuously received, the CPU 211 counts time. The CPU 211 transmits control signals to the units to convey the sheet, counts time during which the Low level signals are continuously received, and detects, when the counted time exceeds a predetermined time, that a jam occurs. Predetermined time used for this determination is stored in the ROM 226 or the like in advance.

For this purpose, the CPU 211 stores values of the High level and the Low level in the ROM 226 or the like in advance. The CPU 211 compares the values stored in the ROM 226 or the like and values of detection signals and determines whether a level of signals received from the sensors 210 is the High level or the Low level.

When the CPU 211 detects that a jam occurs on the basis of the detection signals received from the sensors 210, the CPU 211 transmits an error code indicating that the jam occurs in the finisher 201 to the CPU 111 of the main body 101. The detection of a jam by the CPU 211 explained above is only an example. Other methods may be used for the detection of a jam.

The conveyance control unit 213 drives a not-shown stepping motor on the basis of the control by the CPU 211. The stepping motor transmits power to conveying rollers of the units of the finisher 201 shown in FIG. 1. Consequently, the conveyance control unit 213 collectively controls the conveyance of a sheet in the finisher 201.

The stapler control unit 222 controls the operation of the stapler 221 shown in FIG. 1. The CPU 211 counts the number of sheets conveyed to the stacker 205 on the basis of detection signals of the sensors 210. When the CPU 211 determines that the number of sheets stacked on the stacker 205 reaches a predetermined number, the stapler control unit 222 causes the stapler 221 to execute stapling.

A communication I/F 251 is an interface that transmits data and a control signal to and receives data and control signal from the scanner and printer communication I/F 151 of the main body 101. The error code and the like are transmitted and received between the main body 101 and the finisher 201 via the communication I/F 251 and the scanner and printer communication I/F 151.

When the CPU 111 of the main body 101 shown in FIG. 2 detects that a jam occurs in the image forming apparatus 100, the CPU 111 specifies a place where the jam occurs. For example, when the CPU 111 detects that a jam occurs on the basis of a detection signal transmitted from any one of the sensors 110, the CPU 111 determines that the jam occurs in the main body 101 of the image forming apparatus 100. Further, for example, when the CPU 111 receives an error code indicating that a jam occurs from the finisher 201, the CPU 111 determines that the jam occurs in the finisher 201 of the image forming apparatus 100.

When the CPU 111 determines that a jam occurs in the main body 101, the CPU 111 controls the main body 101 and the finisher 201 to stop the operation. Further, the CPU 111 notifies, through a notifying unit such as the display unit 10, the user of information for informing that the jam occurs and information for urging the user to remove sheets held up in the main body 101 and the finisher 201.

When the CPU 111 determines that a jam occurs in the finisher 201, the CPU 111 controls the finisher 201 to stop the operation. Further, the CPU 111 controls the switch 55 to discharge sheets held up in the main body 101 to the paper discharge tray 51 of the main body 101.

Further, the CPU 111 notifies, through the notifying unit such as the display unit 10, the user of information for informing that the jam occurs in the finisher 201 and information for urging the user to remove sheets held up in the finisher 201.

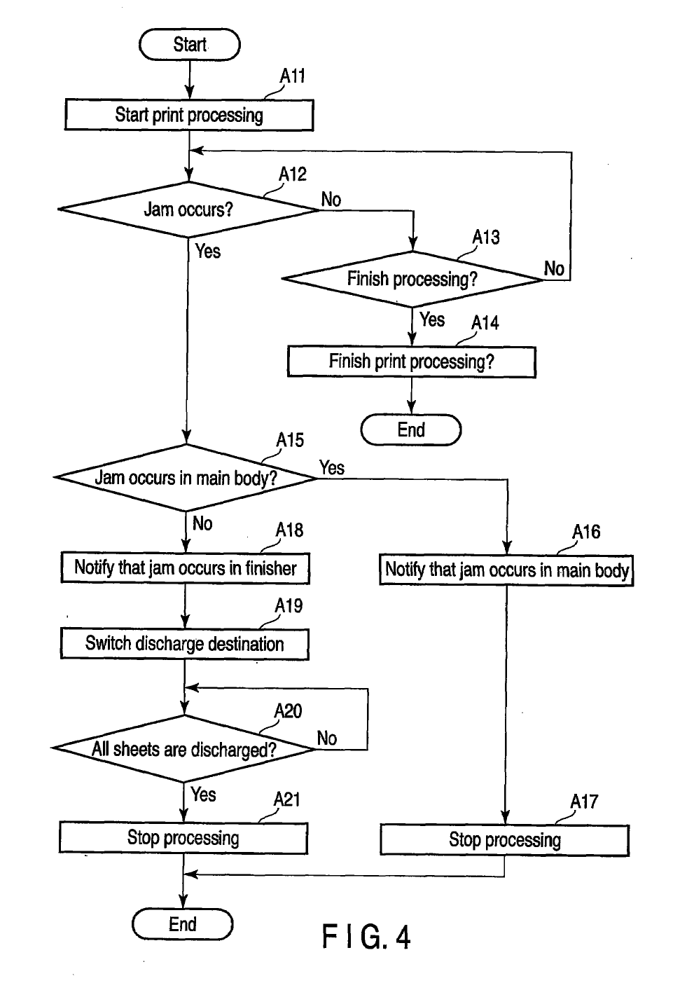

FIG. 4 is a flowchart for explaining the operation of the main body 101. In this embodiment, it is assumed that the finisher 201 is connected to the main body 101. Therefore, the switch 55 sets, during the normal operation of the main body 101, a sheet discharge destination in the discharge port 72 on the side of the main body 101.

When operation for instructing printing is input from the operation unit 9 or the externally-connected host computer PC, the CPU 111 starts print processing (ACT 11).

The CPU 111 sequentially checks whether a jam occurs on the basis of detection signal transmitted from the sensors 110 and a code transmitted from the finisher 201 (ACT 12).

When a jam does not occur (ACT 12, NO), the CPU 111 determines whether the execution of all kinds of instructed print processing is finished (ACT 13).

When the execution of all the kinds of print processing is finished (ACT 13, YES), the CPU 111 finishes the print processing (ACT 14) and shifts to a standby state. When the execution of all the kinds of print processing is not finished (ACT 13, NO), the CPU 111 performs ACT 12 again.

When a jam occurs (ACT 12, YES), the CPU 111 determines whether the jam occurs in the main body 101 (ACT 15). Specifically, the CPU 111 determines whether an error code indicating that the jam occurs is received from the finisher 201.

When the CPU 111 receives the error code indicating that the jam occurs from the finisher 201 to thereby detect that the jam occurs, the CPU 111 determines that the jam occurs in the finisher 201 (ACT 15, NO). When the CPU 111 detects that the jam occurs on the basis of a detection signal transmitted from the sensor 110, the CPU 111 determines that the jam occurs in the main body 101 (ACT 15, YES).

When the CPU 111 judges that the jam occurs in the main body 101 (ACT 15, YES), the CPU 111 notifies, through the notifying unit such as the display unit 10, the user of information for informing that the jam occurs in the main body 101 and information for urging the user to remove sheets held up in the main body 101 and the finisher 201 (ACT 16). In this case, the CPU 111 transmits control signals to the conveyance control unit 125 and the finisher 201 to instruct the conveyance control unit 125 and the finisher 201 to stop the operation in the main body 101 and the finisher 201 (ACT 17) and finishes the processing.

When the CPU 111 determines that the jam occurs in the finisher 201 (ACT 15, NO), the CPU 111 notifies, through the notifying unit such as the display unit 10, the user of information for informing that the jam occurs in the finisher 201 and information for urging the user to remove sheets held up in the finisher 201 (ACT 18). The CPU 111 transmits a control signal for instructing the finisher 201 to stop the conveyance processing to the finisher 201.

When the CPU 211 of the finisher 201 receives the control signal for instructing to stop the conveyance processing, the CPU 211 controls the conveyance control unit 213 and the stapler control unit 222 to stop the operation in the finisher 201.

The CPU 111 controls the switch 55 to switch the sheet discharge destination from the discharge port 72 to the paper discharge tray 51 (ACT 19). In this state, the CPU 111 controls the conveyance control unit 125 to discharge sheets held up in the main body 101 from the paper discharge tray 51.

The CPU 111 determines whether all the sheets held up in the conveying path in the main body 101 are discharged (ACT 20). When all the sheets are discharged (ACT 20, YES), the CPU 111 transmits a control signal to the conveyance control unit 125 to instruct the conveyance control unit 125 to stop the operation in the main body 101 (ACT 21) and finishes the processing.

In this case, the CPU 211 of the finisher 201 sequentially determines whether all the sheets in the finisher 201 are removed. When the CPU 211 determines that all the sheets in the finisher 201 are removed and the jam is solved, the CPU 211 transmits a code indicating that the finisher 201 returns to a normal state to the CPU 111 of the main body 101.

When the CPU 111 of the main body 101 receives the code indicating that the finisher 201 returns to the normal state, the CPU 111 resumes the processing.

As explained above, when a jam occurs, the image forming apparatus 100 specifies a place where the jam occurs. When the jam occurs in the finisher 201 rather than the main body 101, the main body 101 switches the discharge destination for sheets held up in the conveying path therein from the first discharge port, which is connected to the finisher 201, to the second discharge port.

Consequently, when a jam occurs in the finisher 201, it is unnecessary to manually remove sheets held up in the conveying path in the main body 101. As a result, it is possible to provide an image forming apparatus and a control method for the image forming apparatus more convenient than those in the past.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a first conveying unit configured to convey a sheet;
an image forming unit configured to form an image on the sheet conveyed by the first conveying unit;
a switch configured to switch a conveying direction for the sheet having the image formed thereon by the image forming unit to a first direction and to a second direction;
a stacking tray on which the sheet conveyed in the first direction is stacked;
a second conveying unit configured to convey the sheet conveyed in the second direction;
a post-processing unit configured to apply post processing to the sheet conveyed by the second conveying unit;
a first jam detecting unit configured to detect occurrence of a jam in the first conveying unit;
a second jam detecting unit configured to detect occurrence of a jam in the second conveying unit; and
a control unit configured to control, when occurrence of a jam is detected by the second jam detecting unit, the switch to switch a discharge destination for the sheet to the first direction.

2. The apparatus according to claim 1, wherein the control unit controls, when occurrence of a jam is detected by the second jam detecting unit, the second conveying unit to stop the operation thereof.

3. The apparatus according to claim 1, further comprising a notifying unit configured to notify a user of various kinds of information, wherein
the control unit controls, when occurrence of a jam is detected by the second jam detecting unit, the notifying unit to notify the user of information for urging the user to remove sheets held up in the second conveying unit.

4. The apparatus according to claim 1, wherein the control unit controls, when occurrence of a jam is detected by the first jam detecting unit, the first and second conveying unit to stop the operation thereof.

5. The apparatus according to claim 1, further comprising a notifying unit configured to notify a user of various kinds of information, wherein
the control unit controls, when occurrence of a jam is detected by the first jam detecting unit, the notifying unit to notify the user of information for urging the user to remove sheets held up in the first and second conveying units.

6. The apparatus according to claim 1, wherein
the first jam detecting unit includes a first sensor provided near the first conveying unit, and
the first jam detecting unit detects occurrence of a jam in the first conveying unit on the basis of a detection signal detected from the first sensor.

7. The apparatus according to claim 6, wherein the first jam detecting unit counts time during which a state of detection of a detection signal of a level detected from the sensor when a sheet passes or a level detected from the sensor when a sheet does not pass continues and determines, when the counted time exceeds a range set in advance, a jam occurs in the first conveying unit.

8. The apparatus according to claim 1, wherein
the second jam detecting unit includes a second sensor provided near the second conveying unit, and
the second jam detecting unit detects occurrence of a jam in the second conveying unit on the basis of a detection signal detected from the second sensor.

9. The apparatus according to claim 8, wherein the second jam detecting unit counts time during which a state of detection of a detection signal of a level detected from the sensor when a sheet passes or a level detected from the sensor when a sheet does not pass continues and determines, when the counted time exceeds a range set in advance, a jam occurs in the second conveying unit.

10. An image forming apparatus comprising:
a conveying unit configured to convey a sheet;
an image forming unit configured to form an image on the sheet conveyed by the conveying unit;
a switch configured to switch a discharge direction for the sheet having the image formed thereon by the image forming unit to a first direction and to a second direction;
a stacking tray on which the sheet conveyed in the first direction is stacked;
a jam detecting unit configured to detect occurrence of a jam in the conveying unit; and
a control unit configured to control, when an error code is received from an external apparatus connected to the image forming apparatus, the switch to switch the discharge destination for the sheet to the first direction.

11. The image forming apparatus according to claim 10, wherein the control unit controls, when the error code is received from the external apparatus, the external apparatus to stop the operation thereof.

12. The apparatus according to claim 10, further comprising a notifying unit configured to notify a user of various kinds of information, wherein
the control unit controls, when the error code is received from the external apparatus, the notifying unit to notify the user of information for urging the user to remove sheets held up in the external apparatus.

13. The apparatus according to claim 10, wherein the control unit controls, when occurrence of a jam is detected by the jam detecting unit, the conveying unit and the external apparatus to stop the operation thereof.

14. The apparatus according to claim 10, further comprising a notifying unit configured to notify a user of various kinds of information, wherein
the control unit controls, when occurrence of a jam is detected by the jam detecting unit, the notifying unit to notify the user of information for urging the user to remove sheets held up in the conveying unit and the external apparatus.

15. The apparatus according to claim 10, wherein
the jam detecting unit includes a sensor provided near the conveying unit, and
the jam detecting unit detects occurrence of a jam in the conveying unit on the basis of a detection signal detected from the sensor.

16. The apparatus according to claim 15, wherein the jam detecting unit counts time during which a state of detection of a detection signal of a level detected from the sensor when a sheet passes or a level detected from the sensor when a sheet does not pass continues and determines, when the counted time exceeds a range set in advance, a jam occurs in the conveying unit.

17. A control method for an image forming apparatus comprising:
conveying a sheet through a first conveying unit;
forming an image on the sheet conveyed from the first conveying unit;
switching a switch to convey the sheet having the image formed thereon in a second direction;
conveying the sheet, which is conveyed in the second direction, through a second conveying unit;
subjecting the sheet, which is conveyed through the second conveying unit, to post processing;
detecting that a jam does not occur in the first conveying unit and a jam occurs in the second conveying unit;
switching the switch to convey the sheet having the image formed thereon in a first direction; and
stacking the sheet conveyed in the first direction.

18. The method according to claim 17, further comprising detecting that a jam occurs in the second conveying unit and stopping the operation of the second conveying unit.

19. The method according to claim 17, further comprising detecting that a jam occurs in the second conveying unit and notifying a user of information for urging the user to remove sheets held up in the second conveying unit.

20. The method according to claim 17, further comprising detecting that a jam occurs in the first conveying unit, stopping the operation of the first and second conveying units, and notifying a user of information for urging the user to remove sheets held up in the first and second conveying units.
